(19) United States
(12) Patent Application Publication
(10) Pub. No.: US 2026/0194091 A1
(43) Pub. Date: Jul. 9, 2026

(54) Floating Button-Lock Fastener

(71) Applicant: Illinois Tool Works Inc., Glenview, IL (US)

(72) Inventor: Scott M. Liebelt, Eau Claire, WI (US)

(21) Appl. No.: 19/428,784

(22) Filed: Dec. 22, 2025

Related U.S. Application Data
(60) Provisional application No. 63/742,030, filed on Jan. 6, 2025.

(51) Int. Cl. F16B 5/06; B60N 3/04

(52) U.S. Cl. CPC F16B 5/0692; B60N 3/046

(57) ABSTRACT

Described is a button-lock fastener assembly having a first fastener component, and a second fastener component. The first fastener component can be attached to a first component and the second fastener component being embedded in a second component formed using an expanding foam. The second fastener component includes a receiver configured to engage the first fastener component. The receiver is configured to move relative to the second fastener component.

### RELATED APPLICATION

The present application claims priority to U.S. Provisional Patent Application No. 63/742,030 , filed Jan. 6, 2025, and entitled “Floating Buttonlok,” which is hereby incorporated by reference in its entirety.

### BACKGROUND

Automotive components require fastening techniques that are simple to manufacture and assemble. Further, fastening techniques should above all be reliable and efficient. As an example, fasteners for attaching removable components such as mats, carpets, liners, or trim panels are commonly used in automotive, aerospace, marine, and consumer products. In many such applications, the removable component must be securely retained during use while also allowing intentional removal for cleaning, replacement, or maintenance.

In automotive interiors, for example, floor mats are frequently attached to underlying carpeted or foamed structures. These underlying structures are often formed using expanding polyurethane foam, which provides acoustic damping, thermal insulation, and structural support. During the foaming process, fasteners embedded within the foam may become immobilized if foam intrudes into moving or functional regions of the fastener. Such immobilization can lead to poor fit, misalignment, reduced retention strength, or complete fastener failure.

Various button lock and snap-fit fasteners are known in the art, but they often do not adequately address the challenges associated with foam-in-place manufacturing while preserving a floating or self-aligning receiver.

Accordingly, there remains a need for a fastener system that is compatible with foam-in-place processes, provides reliable attachment and detachment, and preserves post-manufacture functionality of a button lock receiver.

### SUMMARY

The present disclosure relates generally to a fastening system to form a connection between the components, substantially as illustrated by and described in connection with at least one of the figures, as set forth more completely in the claims. In one example, the present disclosure relates generally to fastening systems for securing removable components to underlying structures and, more particularly, to a button-lock fastener assembly configured for use in foam-in-place manufacturing processes. The disclosure further relates to fastener assemblies having a floating receiver that is isolated from expanding foam during manufacture to preserve post-manufacture alignment, engagement, and retention functionality.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an assembly view of a fastener system having a button-lock fastener assembly.

FIG. 1b illustrates an assembled view of the fastener system.

FIG. 2a illustrates an isometric assembly view of the button-lock fastener assembly.

FIG. 2b illustrates a side elevation assembly view of the button-lock fastener assembly.

FIG. 2c illustrates an isometric assembled view of the button-lock fastener assembly.

FIG. 2d illustrates a cross-sectional isometric assembled view taken along section A-A of FIG. 2c.

FIGS. 3a and 3b illustrate top and bottom plan views of a first fastener component.

FIGS. 4a and 4b illustrate top and bottom plan views of a receiver.

FIGS. 5a and 5b illustrate top and bottom plan views of a first housing component.

FIGS. 6a and 6b illustrate top and bottom plan views of a second housing component.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastener assembly including a button-lock fastener assembly having a first fastener component attachable to a first component and a second fastener component configured to be embedded within a second component during a foaming process. The second fastener component includes a receiver that is captured between housing components in a manner that allows the receiver to float relative to the housing. In certain examples, the first fastener component is sonic welded to the first component, providing a durable, low-profile attachment suitable for flexible materials such as thermoplastic elastomers (TPE) mats or carpets. In other examples, alternative attachment techniques may be employed. The housing components of the second fastener component are configured to snap together, sandwiching the receiver while preventing rigid fixation thereof. The housing components include radially extending flanges configured to mechanically interlock with expanding foam. In further examples, the receiver includes a receiver body that cooperates with shut-off features of a foaming tool to prevent foam from entering the mold cavity containing the receiver. As a result, the receiver remains free to float after the foaming process is complete.

In a first example, a button-lock fastener assembly comprises: a first fastener component; and a second fastener component, the first fastener component being attachable to a first component and the second fastener component being embedded in a second component formed using an expanding foam, wherein the second fastener component includes a receiver configured to engage the first fastener component, and wherein the receiver is configured to move relative to the second fastener component.

In some examples, the first fastener component includes a body structure and an attachment protrusion extending from the body structure.

In some examples, the attachment protrusion includes a stem body and a bulbous head.

In some examples, the body structure is sonic welded to the first component.

In some examples, the second fastener component includes a first housing component and a second housing component that sandwich the receiver.

In some examples, the first housing component and the second housing component are snap coupled to one another.

In some examples, the receiver is retained between the first housing component and the second housing component such that the receiver floats relative thereto.

In some examples, the receiver is generally annular.

In some examples, the receiver includes a plurality of flexible snap elements oriented toward a central axis.

In some examples, the plurality of flexible snap elements includes three snap elements circumferentially distributed about the central axis.

In some examples, the second fastener component includes radially extending flanges configured to engage the expanding foam.

In some examples, the flanges extend from at least one of the first housing component and the second housing component.

In some examples, the second fastener component defines an opening configured to receive the first fastener component along an axis.

In some examples, the receiver includes a receiver housing configured to cooperate with a foaming tool to prevent foam from contacting the receiver.

In some examples, the receiver remains free to float after completion of a foaming process.

In some examples, the second component includes a polyurethane foam layer.

In some examples, the first component includes a mat or carpet.

In some examples, the first housing component includes a plurality of clips that engage corresponding clips on the second housing component.

In some examples, the receiver allows self-alignment during engagement of the first fastener component with the second fastener component.

In some examples, the button-lock fastener assembly is configured for repeated attachment and detachment of the first component from the second component.

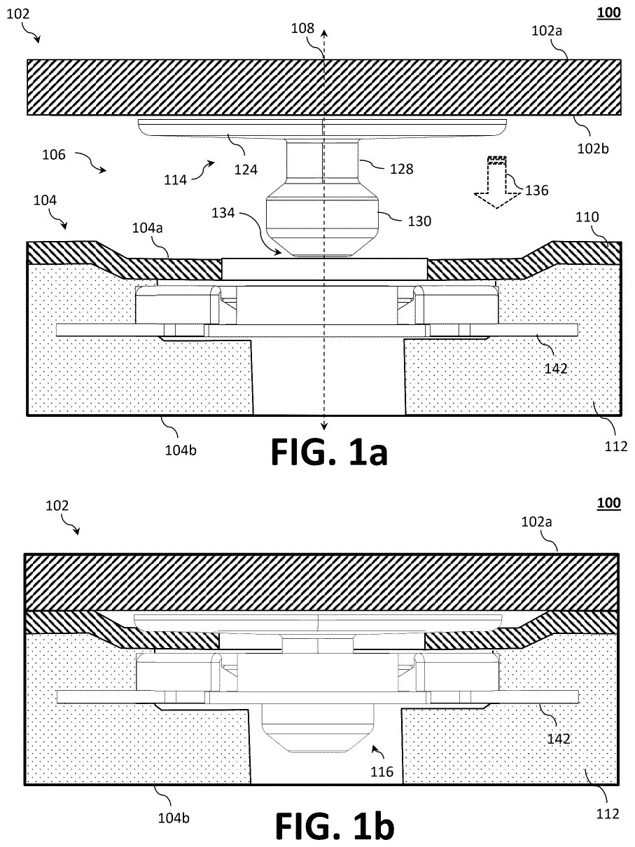

Referring to FIGS. 1a and 1b, a fastener system 100 is illustrated for coupling a first component 102 to a second component 104. The fastener system 100 includes a button-lock fastener assembly 106 that defines a central axis 108. The button-lock fastener assembly 106 may be generally circular (as illustrated), though other shapes are contemplated, such as, oval, polygonal, or otherwise.

The first component 102 includes an A-surface 102a (e.g., a first surface, such as an exterior surface) and an opposite B-surface 102b (e.g., a second surface, such as an interior surface). In one example, the first component 102 is a thermoplastic elastomer (TPE) mat or carpet. In alternative examples, the first component 102 may be a rubber mat, textile-backed carpet, composite mat, or other flexible or semi-rigid article. The second component 104 similarly includes an A-surface 104a and an opposite B-surface 104b. In one example, the second component 104 includes a surface layer 110 (e.g., a TPE carpet layer, skin, or outer finish layer) and a foam core 112 (e.g., an expanding polyurethane foam core). In other examples, the foam may be a different polymeric foam, including polyolefin or elastomeric foams, and may be formed in layers or regions.

The first component 102 can be a mat, carpet, covering, or other such trim piece. The second component 104 may be, for example, a structural component of a vehicle, such as those used on doors, pillars (e.g., an A-pillar, B-pillar, C-pillar, etc.), dashboard components (e.g., a cross member, bracket, frame, etc.), seats, center consoles, or the like. Depending on the application, the first component 102 may be fabricated from TPE, while the second component 104 may be fabricated using expanding polyurethane. In another example, one or both of the first component 102 and the second component 104 can be a multi-material component and, as such, may further comprise, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. For example, as noted, the second component 104 can include a surface layer 110 and foam core 112, which can be dissimilar materials.

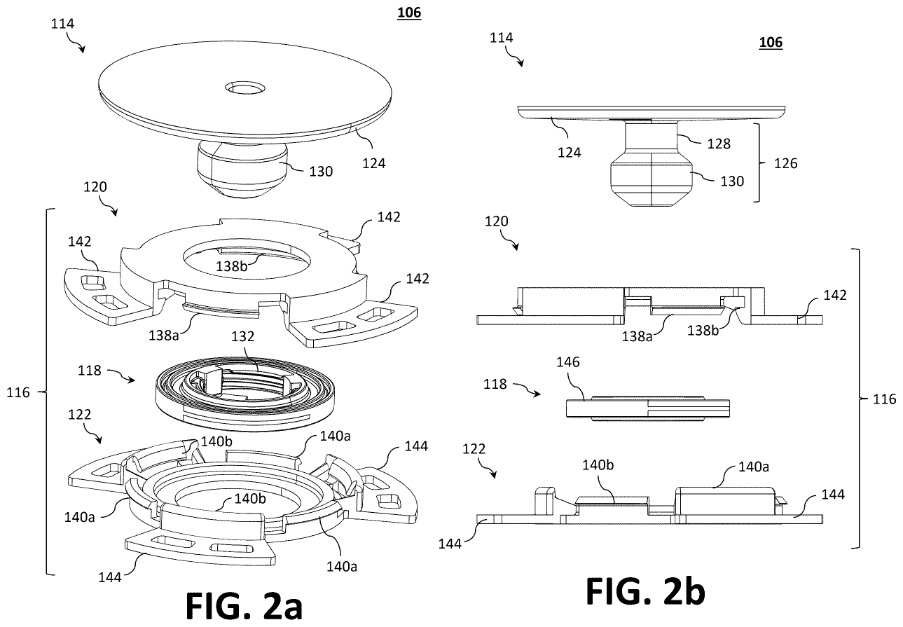

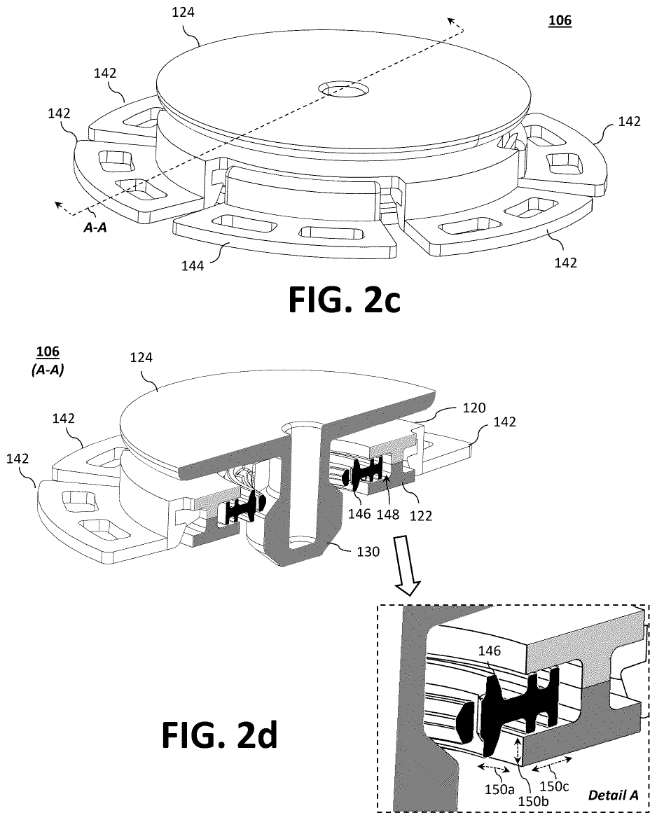

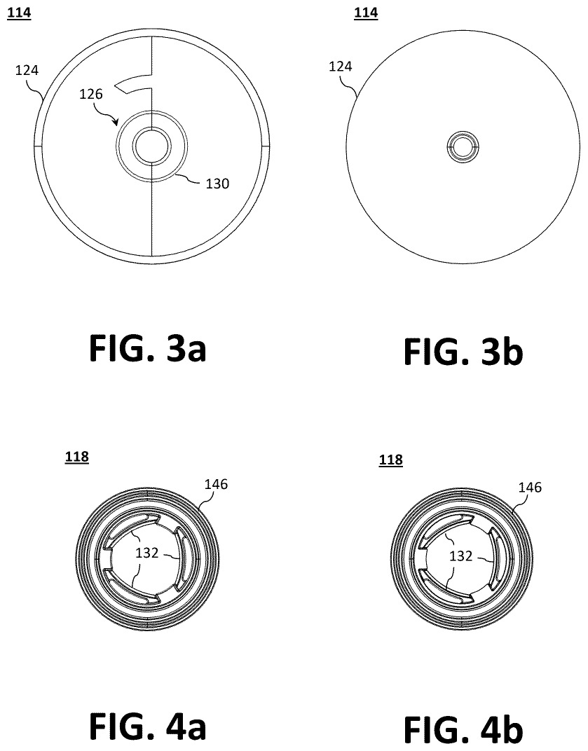

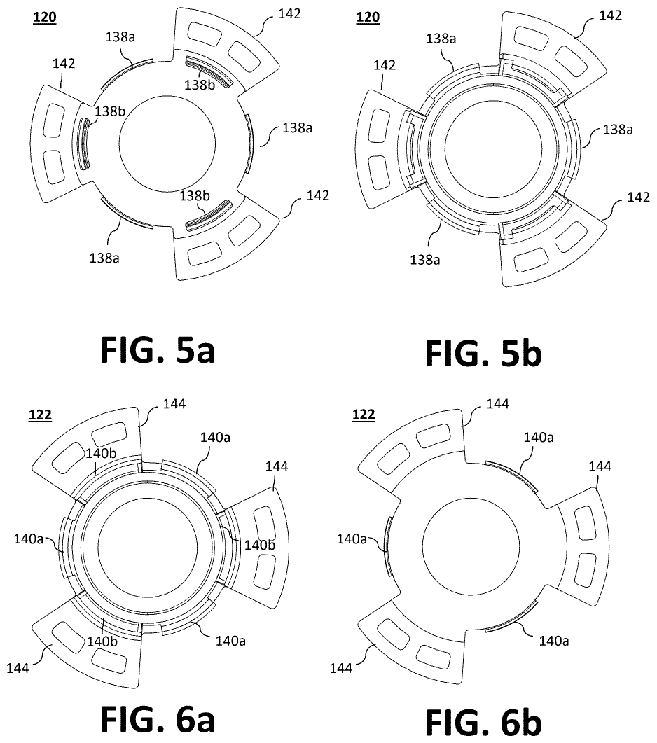

FIG. 2a illustrates an isometric assembly view of the button-lock fastener assembly 106. FIG. 2b illustrates a side elevation assembly view of the button-lock fastener assembly 106. FIG. 2c illustrates an isometric assembled view of the button-lock fastener assembly 106. FIG. 2d illustrates a cross-sectional isometric assembled view taken along section A-A of FIG. 2c. FIGS. 3a and 3b illustrate top and bottom plan views of a first fastener component 114, while FIGS. 4a and 4b illustrate top and bottom plan views of a receiver 118. FIGS. 5a and 5b illustrate top and bottom plan views of a first housing component 120, while FIGS. 6a and 6b illustrate top and bottom plan views of a second housing component 122.

The button-lock fastener assembly 106 includes a first fastener component 114 and a second fastener component 116 configured to selectively engage one another along the central axis 108.

The components of the button-lock fastener assembly 106 (e.g., the first fastener component 114, first housing component 120, second housing component 122, and receiver 118) may each be formed as a unitary structure. For example, the components of the button-lock fastener assembly 106 can be fabricated via mold tooling and a plastic-injection molding process. In another example, the components of the button-lock fastener assembly 106 can be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the components of the button-lock fastener assembly 106 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the fastener 102 may be formed or otherwise fabricated at different resolutions during a printing operation. For example, the carrier portion 102a (or portions thereof) may be printed at a higher resolution than that of the fastener portion 102b or vice versa as needed for a particular application.

Referring to FIGS. 3a and 3b, the first fastener component 114 includes a body structure 124 and an attachment protrusion 126 extending from the body structure 124. The body structure 124 is generally planar and may include surface features, such as ribs, energy directors, or texture, to facilitate attachment to the first component 102.

In an example, the body structure 124 is sonic welded to the B-surface 102b of the first component 102. During sonic welding, ultrasonic energy is applied to the body structure 124, causing localized melting at the interface with the first component 102. Upon cooling, a fused joint is formed. In alternative examples, the body structure 124 may be attached by heat staking, adhesive bonding, mechanical interlocking, overmolding, or combinations thereof.

The attachment protrusion 126 includes a stem body 128 and a bulbous head 130. The bulbous head 130 has a diameter greater than that of the stem body 128 and may be spherical, tapered, or otherwise contoured to facilitate snap engagement.

The attachment protrusion 126 comprises a stem body 128 and a bulbous head 130. The stem body 128 is a generally linear, elongated body, such as a cylindrical or substantially cylindrical post, that extends outwardly from and is integrally formed with, or otherwise secured to, the body structure 124. In one example, the body structure 124 may be a generally planar or disc-shaped base (as illustrated), although other base geometries are contemplated.

The bulbous head 130 is positioned at a distal end of the stem body 128 opposite the body structure 124 and defines an enlarged portion having at least one transverse dimension greater than a corresponding transverse dimension of the stem body 128. The bulbous head 130 may be spherical, hemispherical, frustoconical, tapered, mushroom-shaped, or otherwise contoured to facilitate resilient deformation and snap-fit engagement with a complementary receiving structure (e.g., the receiver 118).

In operation, the reduced diameter of the stem body 128 relative to the bulbous head 130 allows the bulbous head 130 to elastically compressed and/or deflect a portion of the receiver 118 (e.g., the flexible snap elements 132) during insertion into the receiver 118 and subsequently to resist withdrawal, thereby providing a releasable or semi-permanent mechanical attachment. The stem body 128 may have a uniform cross-section or may include localized tapering, fillets, or transitions to distribute stress and improve durability during repeated attachment and detachment cycles.

The attachment protrusion 126 may be formed as a single, unitary component with the body structure 124, such as by molding, casting, or additive manufacturing, or may be formed as a separate element that is mechanically or adhesively secured thereto. Materials for the attachment protrusion 126 may include plastics, elastomers, metals, or composite materials selected to provide the desired balance of stiffness, flexibility, and wear resistance.

The second fastener component 116 includes a first housing component 120, a second housing component 122, and the receiver 118 positioned between the housing components. Together, these components define an opening 134 configured to receive the attachment protrusion 126 in the direction indicated by arrow 136, which is parallel to the central axis 108.

Referring to FIGS. 4a and 4b, the receiver 118 is generally annular and includes a plurality of flexible snap elements 132 formed on an inner surface. The snap elements 132 extend toward the central axis 108 and are configured to deflect as the bulbous head 130 passes therethrough. Although three snap elements 132 are illustrated, alternative examples may include two, four, or more snap elements depending on desired retention force and release characteristics.

The first housing component 120 and the second housing component 122 are configured to be releasably coupled to one another using cooperating attachment features, such as clips 138a, 138b, 140a, and 140b. The attachment features may include resilient snap clips, ledges, barbs, detents, or functionally similar engagement structures. In the illustrated embodiment, the first housing component 120 includes first clips 138a and 138b, and the second housing component 122 includes second clips 140a and 140b. As illustrated, certain clips are oriented outwardly from the central axis 108, while other clips are oriented inwardly toward the central axis 108. During assembly, the first clips 138a are snapably engaged with corresponding second clips 140a, and the first clips 138b are snapably engaged with corresponding second clips 140b, thereby securing the first and second housing components 120, 122 together. When assembled, the first housing component 120 and the second housing component 122 cooperatively define an annular cavity 148 (e.g., defined by a pair of annular ledges) configured to receive and retain the receiver 118 (e.g., via the rim, edge, or perimeter of the receiver 118).

The receiver 118 is disposed within the annular cavity 148 such that it is retained between the first housing component 120 and the second housing component 122 without being rigidly fixed thereto. In particular, the annular cavity 148 and/or one or more retaining features are dimensioned and configured to permit limited relative movement of the receiver 118 with respect to the housing components. With reference to FIG. 2d (Detail A), this relative movement may include radial movement (arrow 150a), axial movement (arrows 150b, 150c), angular movement, or combinations thereof, thereby allowing the receiver 118 to “float” within the housing.

The floating arrangement permits the receiver 118 to self-center or self-align with the attachment protrusion 126 as the attachment protrusion 126 is inserted into the receiver 118. By accommodating manufacturing tolerances, misalignment between components, foaming manufacturing, and insertion angle variation, the floating capability reduces insertion forces, minimizes localized stress concentrations, and decreases the likelihood of damage to the receiver 118, the attachment protrusion 126, or the housing components 120, 122. In some embodiments, the floating movement may be constrained within predefined limits by stops, compliant walls, resilient members, or spacing features formed in one or both of the housing components.

Each housing component includes radially extending flanges 142 and 144. The flanges are configured to embed within the foam core 112, thereby anchoring the second fastener component 116 within the second component 104. The flanges may vary in thickness, length, curvature, or number to accommodate different foam densities and expansion characteristics.

The receiver 118 includes or is associated with a receiver body 146 that cooperates with shut-off features of a foaming tool. During the foaming process, the housing 146 and the tool shut-offs prevent foam from entering the mold cavity containing the receiver 118. This isolation prevents foam from bonding to or immobilizing the receiver 118.

After the foaming process is complete, the receiver 118 remains free to float relative to the housing components 120 and 122, thereby preserving the snap engagement functionality of the flexible snap elements 132.

In an example installation, the first fastener component 114 is sonic welded to a TPE mat forming the first component 102. In another example, the first fastener component 114 is integrally formed with the first component 102. The second fastener component 116 is placed into a mold and embedded in polyurethane foam forming the second component 104. After manufacture, the mat is aligned with the underlying structure, and the attachment protrusion 126 is pressed into the receiver 118 until the snap elements 132 engage the bulbous head 130, thereby securing the mat in place.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A button-lock fastener assembly comprising:
a first fastener component; and
a second fastener component, the first fastener component being attachable to a first component and the second fastener component being embedded in a second component formed using an expanding foam,
wherein the second fastener component includes a receiver configured to engage the first fastener component, and
wherein the receiver is configured to move relative to the second fastener component.

2. The button-lock fastener assembly of claim 1, wherein the first fastener component includes a body structure and an attachment protrusion extending from the body structure.

3. The button-lock fastener assembly of claim 2, wherein the attachment protrusion includes a stem body and a bulbous head.

4. The button-lock fastener assembly of claim 2, wherein the body structure is sonic welded to the first component.

5. The button-lock fastener assembly of claim 1, wherein the second fastener component includes a first housing component and a second housing component to sandwich the receiver.

6. The button-lock fastener assembly of claim 5, wherein the first housing component and the second housing component are snap coupled to one another.

7. The button-lock fastener assembly of claim 5, wherein the receiver is retained between the first housing component and the second housing component such that the receiver floats relative thereto.

8. The button-lock fastener assembly of claim 1, wherein the receiver is generally annular.

9. The button-lock fastener assembly of claim 8, wherein the receiver includes a plurality of flexible snap elements oriented toward a central axis.

10. The button-lock fastener assembly of claim 9, wherein the plurality of flexible snap elements includes three snap elements circumferentially distributed about the central axis.

11. The button-lock fastener assembly of claim 5, wherein the second fastener component includes radially extending flanges configured to engage the expanding foam.

12. The button-lock fastener assembly of claim 11, wherein the flanges extend from at least one of the first housing component and the second housing component.

13. The button-lock fastener assembly of claim 1, wherein the second fastener component defines an opening configured to receive the first fastener component along an axis.

14. The button-lock fastener assembly of claim 1, wherein the receiver includes a receiver housing configured to cooperate with a foaming tool to prevent foam from contacting the receiver.

15. The button-lock fastener assembly of claim 14, wherein the receiver remains free to float after completion of a foaming process.

16. The button-lock fastener assembly of claim 1, wherein the second component includes a polyurethane foam layer.

17. The button-lock fastener assembly of claim 1, wherein the first component includes a mat or carpet.

18. The button-lock fastener assembly of claim 6, wherein the first housing component includes a plurality of clips that engage corresponding clips on the second housing component.

19. The button-lock fastener assembly of claim 1, wherein the receiver allows self-alignment during engagement of the first fastener component with the second fastener component.

20. The button-lock fastener assembly of claim 1, wherein the button-lock fastener assembly is configured for repeated attachment and detachment of the first component from the second component.
